(19) United States
(12) Patent Application Publication
(10) Pub. No.: US 2014/0354393 A1
(43) Pub. Date: Dec. 4, 2014

(54) ELECTRONIC APPARTUS

(71) Applicant: KABUSHIKI KAISHA TOSHIBA, Tokyo (JP)

(72) Inventor: Yutaka Horie, Mitaka-shi (JP)

(73) Assignee: KABUSHIKI KAISHA TOSHIBA, Tokyo (JP)

(21) Appl. No.: 14/074,537

(22) Filed: Nov. 7, 2013

(30) Foreign Application Priority Data
May 31, 2013 (JP) 2013-115847

(51) Int. Cl. H01F 27/06

(52) U.S. Cl. CPC H01F 27/06
USPC 336/208

(57) ABSTRACT

According to one embodiment, an electronic apparatus includes a substrate including a mount surface, a choke coil attached to the mount surface of the substrate, and a first metallic layer electrically connected to the choke coil. The first metallic layer stretches into a planar shape along the substrate, and includes a first opening at a position corresponding to the choke coil.

### CROSS-REFERENCE TO RELATED APPLICATIONS

This application is based upon and claims the benefit of priority from Japanese Patent Application No. 2013-115847, filed May 31, 2013, the entire contents of which are incorporated herein by reference.

### FIELD

Embodiments described herein relate generally to an electronic apparatus comprising a choke coil.

### BACKGROUND

An electronic apparatus which houses a substrate comprising a DC/DC converter is known. The DC/DC converter is an element for providing components housed inside the electronic apparatus with appropriate voltage. Therefore, a DC/DC converter with high efficiency and its surrounding structures have been required in order to obtain the desired voltage without any loss inside the electronic apparatus.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective illustration of a portable computer according to a first embodiment;

FIG. 2 is an exemplary perspective illustration showing a part of a substrate module housed in a housing of the portable computer in an enlarged scale in the first embodiment;

FIG. 3 is an exemplary plan view of the substrate module shown in FIG. 2;

FIG. 4 is an exemplary cross-sectional view taken along line F4-F4 of FIG. 3;

FIG. 5 is an exemplary cross-sectional view of a substrate module housed in a housing of a portable computer in a second embodiment;

FIG. 6 is an exemplary cross-sectional view of a substrate module housed in a housing of a portable computer in a third embodiment; and

FIG. 7 is an exemplary cross-sectional view of a substrate module housed in a housing of a portable computer in a fourth embodiment.

### DETAILED DESCRIPTION

Various embodiments will be described hereinafter with reference to the accompanying drawings. In general, according to one embodiment, an electronic apparatus comprises a substrate comprising a mount surface, a choke coil attached to the mount surface of the substrate, and a first metallic layer electrically connected to the choke coil. The first metallic layer stretches into a planar shape along the substrate, and comprises a first opening at a position corresponding to the choke coil.

### First Embodiment

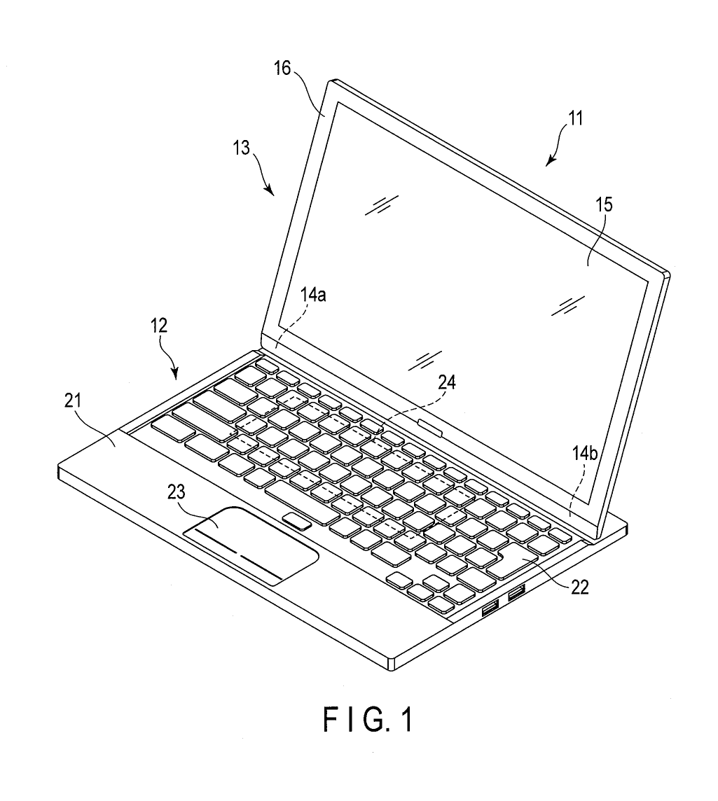

Hereinafter, an electronic apparatus of a first embodiment is explained with reference to FIG. 1 to FIG. 4.

FIG. 1 discloses a portable computer 11 which is an example of the electronic apparatus. The portable computer 11 comprises a main body 12, a display 13, and a pair of hinges 14a and 14b between the main body 12 and the display 13. The hinges 14a and 14b rotatably attach the display 13 to the main body 12.

The display 13 comprises a display panel 15 and a display case 16. The display panel 15 is constructed by a liquid crystal display panel. Apart from the liquid crystal display panel, other types of display panel may be used in order to construct the display panel 15. For example, a plasma display panel, an organic EL panel, a plastic display panel and a sheet display panel may be employed. The display case 16 is formed from a synthetic resin material and surrounds the display panel 15.

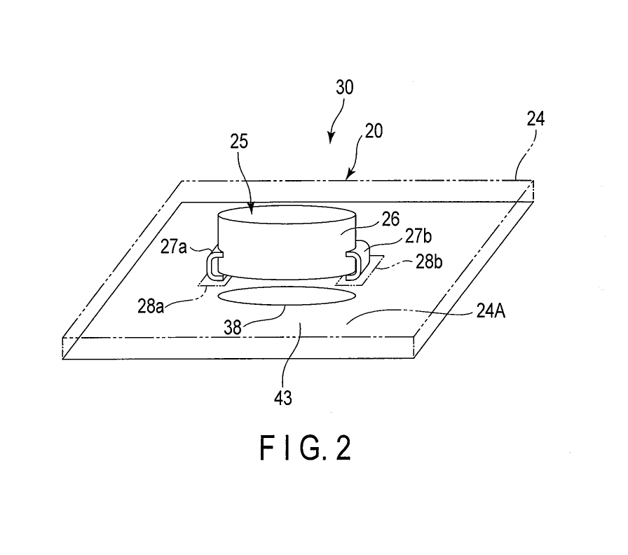

As shown in FIG. 1 and FIG. 2, the main body 12 comprises a housing 21. The housing 21 is formed from, for example, a synthetic resin material, into a box shape. A keyboard 22 and a touch pad 23 are provided on the top surface of the housing 21. Further, a substrate 24 is housed inside the housing 21. The substrate 24 can be rephrased as a mother board or a main board.

The substrate 24 comprises a mount surface 24A. A DC/DC converter 20 is attached on the mount surface 24A of the substrate 24. The substrate 24 and the DC/DC converter 20 constitute a substrate module 30 in cooperation with each other. The substrate module 30 can be rephrased as a module or a printed circuit board.

The DC/DC converter 20 is an element for converting a DC voltage obtained by an AC adapter into a DC voltage which is suitable for each component on the substrate 24. The DC/DC converter 20 comprises a control IC, a switching element, a driver configured to drive the switching element, a choke coil 25 and a capacitor. The control IC, the switching element, the driver, the choke coil 25 and the capacitor are on the mount surface 24A of the substrate 24. The control IC, the switching element, the driver and the capacitor are around the choke coil 25.

As indicated in FIG. 2, the choke coil 25 comprises, for example, a columnar coil main body 26, and a pair of terminals 27a and 27b protruding from the coil main body 26. The terminals 27a and 27b are attached to a pair of pads 28a and 28b on the mount surface 24A of the substrate 24 by means of, for example, soldering. Therefore, the choke coil 25 is electrically connected to the pads 28a and 28b.

As illustrated in FIG. 4, the choke coil 25 comprises a winding portion 31 and a core material 32 such as ferrite. The winding portion 31 is housed inside the coil main body 26, and is circularly wound along a thickness direction of the substrate 24. The core material 32 is inside the winding portion 31. The choke coil 25 of the first embodiment is excellent in a saturation property since the core material 32 is used.

As indicated in FIG. 4, the substrate 24 is a multilayer printed wiring board formed by stacking a plurality of metallic layers. Specifically, the substrate 24 comprises a first metallic layer 33 on the mount surface 24A side, a first intermediate metallic layer 34 which is more distant from the choke coil 25 than the first metallic layer 33, a second intermediate metallic layer 42 which is more distant from the choke coil 25 than the first intermediate metallic layer 34, and a second metallic layer 43 which is more distant from the choke coil 25 than the second intermediate metallic layer 42. In other words, between the first metallic layer 33 and the second metallic layer 43, the first intermediate metallic layer 34 and the second intermediate metallic layer 42 are interposed. The first metallic layer 33, the first intermediate metallic layer 34, the second intermediate metallic layer 42 and the second metallic layer 43 are electrically insulated by an insulating layer 35.

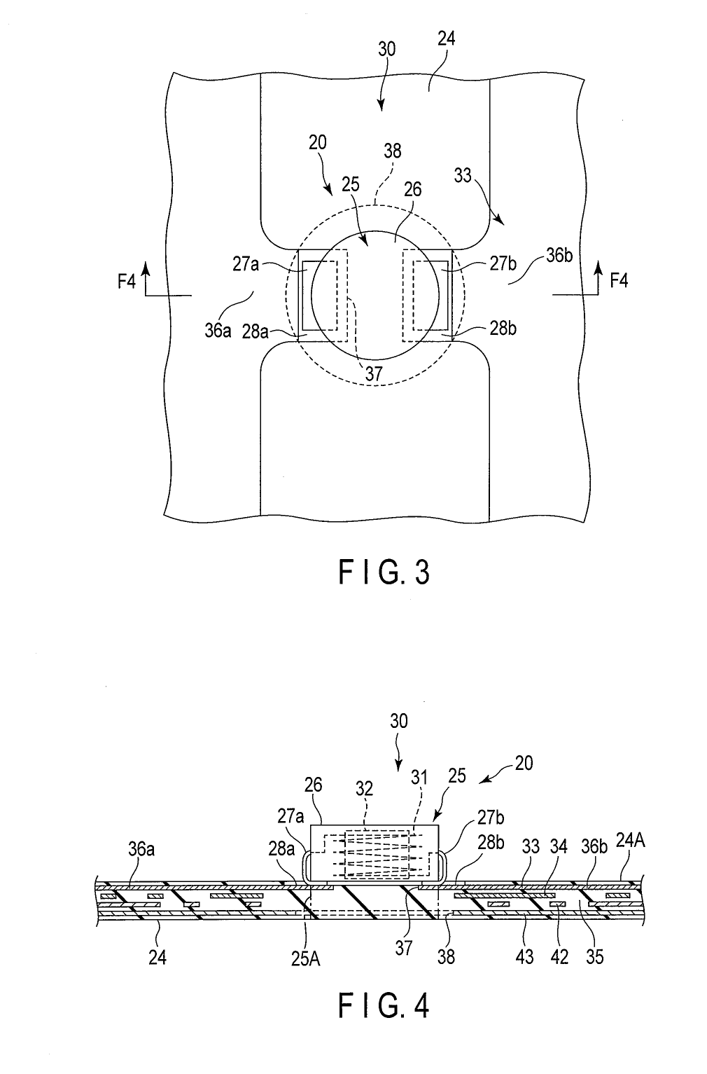

As shown in FIG. 3, the first metallic layer 33 comprises a plurality of metallic lines formed from, for example, a copper material. The first metallic layer 33 comprises the pads 28a and 28b to which the terminals 27a and 27b of the choke coil 25 are connected, wiring portions 36a and 36b stretching into a planar shape along the mount surface 24A, and a first opening 37 in a portion 25A corresponding to the choke coil 25. In other words, the first metallic layer 33 is outside the choke coil 25 except for a part of the pads 28a and 28b.

The second metallic layer 43 is formed from, for example, a copper material. The second metallic layer 43 is formed as a so-called solid patterned member which stretches into a planar shape along the mount surface 24A inside the substrate 24. Therefore, the second metallic layer 43 functions as, for example, a ground layer, and also functions as a heat radiating portion for radiating heat accumulated in the substrate 24 to the outside of the substrate 24.

As shown in FIG. 3 and FIG. 4, the second metallic layer 43 comprises, in the portion corresponding to the choke coil 25, for example, a circular second opening 38. The size of the second opening 38 is suitable for the amount of magnetic flux leaking from the choke coil 25. The size of the second opening 38 refers to the diameter or area of the second opening 38. In the first embodiment, the size of the second opening 38 is at least substantially equal to the size (diameter or area) of the choke coil 25. Therefore, the second metallic layer 43 can be also explained as being located outside the choke coil 25.

The second metallic layer 43 may be a power source layer comprising the same structures as the above. Moreover, the core material 32 may be omitted from the choke coil 25. In the choke coil 25 without the core material 32, the amount of magnetic flux leaking from the choke coil 25 into its surrounding area tends to increase. Therefore, the size of the second opening 38 is preferably larger than the size of the choke coil 25.

As illustrated in FIG. 4, similarly to the first metallic layer 33 and the second metallic layer 43, the first intermediate metallic layer 34 and the second intermediate metallic layer 42 are outside the portion 25A corresponding the choke coil 25.

In the first embodiment, each of the first metallic layer 33, the first intermediate metallic layer 34, the second intermediate metallic layer 42 and the second metallic layer 43 is outside the portion 25A corresponding to the choke coil 25. Therefore, no conductor exits in the portion 25A corresponding to the choke coil 25 in the substrate 24. Thus, no eddy-current loss is caused in the portion 25A of the substrate 24 due to a magnetic field generated by the choke coil 25.

According to the first embodiment, the substrate module 30 of the portable computer 11 comprises the substrate 24, the choke coil 25 attached to the mount surface 24A of the substrate 24, and the first metallic layer 33 electrically connected to the choke coil 25. The first metallic layer 33 stretches into a planar shape on the mount surface 24A side of the substrate 24, and comprises the first opening 37 in the portion 25A corresponding to the choke coil 25.

In this structure, since the first metallic layer 33 does not overlap with the choke coil 25, no eddy-current loss is caused in the first metallic layer 33 due to the magnetic field generated by the choke coil 25. Therefore, the DC/DC converter 20 can be operated with high efficiency.

The second metallic layer 43 as a ground layer is more distant from the choke coil 25 along the thickness direction of the substrate 24 than the first metallic layer 33. Further, the second metallic layer 43 stretching into a planar shape along the substrate 24 comprises the second opening 38 in the portion corresponding to the choke coil 25.

According to this structure, as the second metallic layer 43 does not overlap with the choke coil 25, no eddy-current loss is caused in the second metallic layer 43 due to the magnetic field generated by the choke coil 25. Thus, the DC/DC converter 20 can be further efficiently operated.

### Second Embodiment

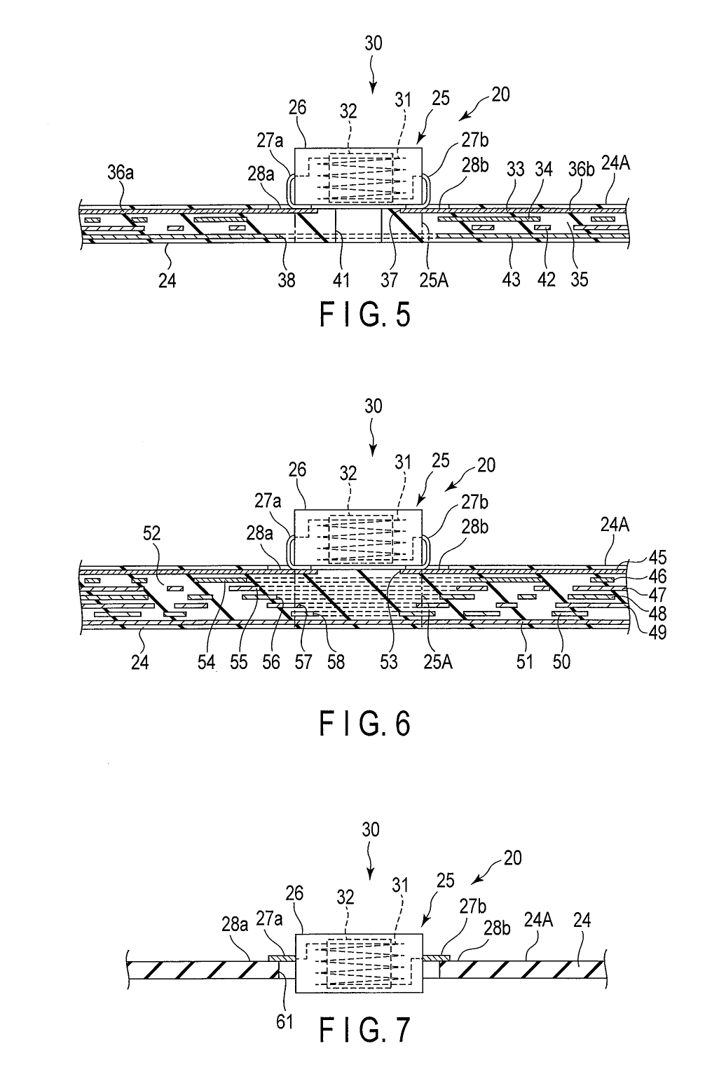

FIG. 5 discloses a second embodiment. The second embodiment is different from the first embodiment in respect that a substrate 24 comprises a through hole 41. In the other structures, the second embodiment is common to the first embodiment. Therefore, in the second embodiment, the structures different from those in the first embodiment are mainly explained. The structures identical to those in the first embodiment are denoted by the same reference numerals as in the first embodiment, and their explanations will be omitted.

As indicated in FIG. 5, the substrate 24 is a multilayer printed wiring board formed by stacking a first metallic layer 33, a first intermediate metallic layer 34, a second intermediate metallic layer 42 and a second metallic layer 43. Moreover, the through hole 41 of the substrate 24 penetrates the substrate 24 at a position corresponding to a choke coil 25 in a thickness direction.

In the second embodiment, the substrate 24 comprises the through hole 41 at the position corresponding to the choke coil 25. According to this structure, there is no conductor at the position corresponding to the choke coil 25 in the substrate 24. This prevents an eddy-current loss from being caused in the portion corresponding to the choke coil 25 in the substrate 24. Thus, it is possible to provide a portable computer comprising a DC/DC converter 20 with high efficiency.

### Third Embodiment

FIG. 6 discloses a third embodiment. The third embodiment is different from the first embodiment in terms of the structure of a substrate 24. In the other structures, the third embodiment is common to the first embodiment. Therefore, in the third embodiment, the structures different from those in the first embodiment are mainly explained. The structures identical to those in the first embodiment are denoted by the same reference numerals as in the first embodiment, and their explanations will be omitted.

As shown in FIG. 6, the substrate 24 is a multilayer printed wiring board formed by stacking a plurality of metallic layers. Specifically, the substrate 24 comprises a first metallic layer 45 on a mount surface 24A side, a first intermediate metallic layer 46 which is more distant from a choke coil 25 than the first metallic layer 45, a second intermediate metallic layer 47 which is more distant from the choke coil 25 than the first intermediate metallic layer 46, a third intermediate metallic layer 48 which is more distant from the choke coil 25 than the second intermediate metallic layer 47, a fourth intermediate metallic layer 49 which is more distant from the choke coil 25 than the third intermediate metallic layer 48, a fifth intermediate metallic layer 50 which is more distant from the choke coil 25 than the fourth intermediate metallic layer 49, and a second metallic layer 51 which is more distant from the choke coil 25 than the fifth intermediate metallic layer 50. In other words, between the first metallic layer 45 and the second metallic layer 51, the first to fifth intermediate metallic layers 46, 47, 48, 49 and 50 are located. Each of the metallic layers 45, 46, 47, 48, 49, 50 and 51 is electrically insulated by an insulating layer 52.

The first metallic layer 45 comprises a plurality of metallic lines formed from, for example, a copper material. The first metallic layer 45 stretches into a planar shape along the mount surface 24A of the substrate 24. Further, the first metallic layer 45 comprises pads 28a and 28b connected to terminals 27a and 27b of the choke coil 25, and a first opening 53 in a portion 25A corresponding to the choke coil 25.

The first intermediate layer 46 comprises a plurality of metallic lines formed by, for example, a copper material. The first intermediate metallic layer 46 comprises a first intermediate opening 54 having, for example, a circular shape, in the portion 25A corresponding to the choke coil 25. The size (diameter, area) of the first intermediate opening 54 is larger than the size (diameter, area) of the choke coil 25.

The second intermediate metallic layer 47 comprises a plurality of metallic lines formed from, for example, a copper material. The second intermediate metallic layer 47 comprises a second intermediate opening 55 having, for example, a circular shape, in the portion 25A corresponding to the choke coil 25. The size (diameter, area) of the second intermediate opening 55 is smaller than the size (diameter, area) of the first intermediate opening 54.

The third intermediate metallic layer 48, the fourth intermediate metallic layer 49 and the fifth intermediate metallic layer 50 are formed from, for example, copper materials. The third intermediate metallic layer 48 comprises a third intermediate opening 56 having, for example, a circular shape, in the portion 25A corresponding to the choke coil 25. The size (diameter, area) of the third intermediate opening 56 is smaller than the size (diameter, area) of the second intermediate opening 55.

The fourth intermediate metallic layer 49 comprises a fourth intermediate opening 57 having, for example, a circular shape, in the portion 25A corresponding to the choke coil 25. The size (diameter, area) of the fourth intermediate opening 57 is smaller than the size (diameter, area) of the third intermediate opening 56.

The fifth intermediate metallic layer 50 comprises a fifth intermediate opening 58 having, for example, a circular shape, in the portion 25A corresponding to the choke coil 25. The size (diameter, area) of the fifth intermediate opening 58 is smaller than the size (diameter, area) of the fourth intermediate opening 57.

The second metallic layer 51 is formed from, for example, a copper material. The second metallic layer 51 is the most distant from the choke coil 25 inside the substrate 24. The second metallic layer 51 is formed as a so-called solid patterned member which stretches into a planar shape along the mount surface 24A inside the substrate 24. Therefore, the second metallic layer 51 functions as, for example, a ground layer, and also functions as a heat radiating portion for radiating heat accumulated in the substrate 24 to the outside of the substrate 24. Moreover, the second metallic layer 51 does not comprise an opening in the portion 25A corresponding to the choke coil 25.

In the third embodiment, the sizes of the openings 53, 54, 55, 56, 57 and 58 of the metallic layers 45, 46, 47, 48, 49 and 50 respectively become smaller in this order. Therefore, the generation of an eddy current in each of the metallic layers 45, 46, 47, 48, 49 and 50 due to a magnetic field generated by the choke coil 25 can be prevented as much as possible.

The second metallic layer 51 without an opening is the most distant from the choke coil 25 along the thickness direction of the substrate 24. Therefore, the second metallic layer 51 is less affected from the magnetic field generated by the choke coil 25. Thus, even if an eddy-current loss is caused in the second metallic layer 51, the effect of the eddy-current loss can be reduced.

According to the third embodiment, the second intermediate metallic layer 47 of the substrate 24 is more distant from the choke coil 25 than the first intermediate metallic layer 46 in the thickness direction of the substrate 24. Moreover, the second intermediate metallic layer 47 comprises the second intermediate opening 55 at the position corresponding to the choke coil 25. The size of the second intermediate opening 55 is smaller than the first intermediate opening 54.

In this structure, the second intermediate metallic layer 47 is more distant from the choke coil 25 than the first intermediate metallic layer 46. Therefore, compared with the first metallic layer 45 and the first intermediate metallic layer 46, an eddy current is difficult to be generated in the second intermediate metallic layer 47 due to the magnetic field from the choke coil 25. Thus, even if the size of the second intermediate opening 55 is smaller than the size of the first intermediate opening 54, it is possible to constrain the eddy-current loss, and provide a portable computer comprising a DC/DC converter 20 with high efficiency.

The second metallic layer 51 which stretches into a planar shape inside the substrate 24 is more distant from the choke coil 25 along the thickness direction of the substrate 24 than the second intermediate metallic layer 47. According to this structure, compared with the first to fifth intermediate metallic layers 46, 47, 48, 49 and 50, an eddy current is difficult to be generated in the second metallic layer 51 due to the magnetic field from the choke coil 25. Therefore, even if the second metallic layer 51 does not comprise an opening and stretches into a planar shape, the effect of the eddy current generated in the second metallic layer 51 can be diminished.

### Fourth Embodiment

FIG. 7 discloses a fourth embodiment. The fourth embodiment is different from the first embodiment in terms of the matters regarding the layout of a choke coil 25. In the other structures, the fourth embodiment is common to the first embodiment. Therefore, in the fourth embodiment, the structures different from those in the first embodiment are mainly explained. The structures identical to those in the first embodiment are denoted by the same reference numerals as in the first embodiment, and their explanations will be omitted.

A substrate 24 is a multilayer printed wiring board formed by stacking a plurality of metallic layers. The substrate 24 comprises a through hole 61. The through hole 61 penetrates the substrate 24 in its thickness direction. The choke coil 25 of a DC/DC converter 20 is inside the through hole 61 of the substrate 24.

The choke coil 25 comprises tabular terminals 27a and 27b protruding from a coil main body 26. The terminals 27a and 27b are attached to pads 28a and 28b of the substrate 24 by means of, for example, soldering. Therefore, the choke coil 25 is electrically connected to the pads 28a and 28b.

In the fourth embodiment, the choke coil 25 is inside the through hole 61 of the substrate 24. By this structure, no conductor is allocated at a position where an eddy current is generated due to the effect of a magnetic field from the choke coil 25.

According to the fourth embodiment, the DC/DC converter 20 comprises the substrate 24 comprising the through hole 61, and the choke coil 25 attached to the substrate 24 inside the through hole 61. This structure prevents the generation of an eddy current in the metallic layers inside the substrate 24 due to the magnetic field generated by the choke coil 25.

The electronic apparatus is not limited to the portable computer shown in the above embodiments. The embodiments are also applicable to other types of electronic apparatus such as a television, a mobile phone, a smart phone, a tablet, and an electronic book reader which electrically displays books, images and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a substrate comprising a mount surface;
a choke coil attached to the mount surface of the substrate; and
a first metallic layer which is electrically connected to the choke coil, stretches into a planar shape along the substrate, and comprises a first opening at a position corresponding to the choke coil.

2. The electronic apparatus of claim 1, wherein the substrate comprises a second metallic layer which is more distant from the choke coil than the first metallic layer, and the second metallic layer stretches into a planar shape along the substrate and comprises a second opening at a position corresponding to the choke coil.

3. The electronic apparatus of claim 2, wherein the substrate comprises a plurality of intermediate metallic layers between the first metallic layer and the second metallic layer, and each of the intermediate metallic layers comprises an intermediate opening at a position corresponding to the choke coil.

4. The electronic apparatus of claim 3, wherein the intermediate opening of the intermediate metallic layer on a second metallic layer side has a smaller size than the intermediate opening of the intermediate metallic layer on a first metallic layer side.

5. The electronic apparatus of claim 1, wherein the substrate comprises a through hole penetrating the substrate at a position corresponding to the choke coil.

6. The electronic apparatus of claim 5, wherein the choke coil is attached to the substrate in order to penetrate the through hole.

7. The electronic apparatus of claim 2, wherein a size of the second opening is at least equal to a size of the choke coil.

8. An electronic apparatus comprising:
a substrate comprising a through hole; and
a choke coil attached to the substrate in order to be inside the through hole.

9. An electronic apparatus comprising:
a substrate comprising a mount surface;
a choke coil attached to the mount surface of the substrate; and
a metallic layer which is on a mount surface side of the substrate, is electrically connected to the choke coil, and is outside the choke coil.

10. The electronic apparatus of claim 9, wherein the metallic layer is configured to stretch into a planar shape along the mount surface inside the substrate.
